(19) United States
(12) Patent Application Publication
(10) Pub. No.: US 2014/0224712 A1
(43) Pub. Date: Aug. 14, 2014

(54) SLIDING DRAWER ASSEMBLY FOR INLINE CARBON SCREENS

(71) Applicant: MID-CONTINENT COAL AND COKE CO., Cleveland, OH (US)

(72) Inventors: Mark Maupin, Logan, AL (US); Wes May, Birmingham, AL (US); Ben Rankin, Columbiana, AL (US)

(73) Assignee: MID-CONTINENT COAL AND COKE CO., Cleveland, OH (US)

(21) Appl. No.: 14/175,131

(22) Filed: Feb. 7, 2014

Related U.S. Application Data
(60) Provisional application No. 61/762,498, filed on Feb. 8, 2013.

(51) Int. Cl. B07B 1/55; B07B 1/46

(52) U.S. Cl. CPC B07B 1/55; B07B 1/46
USPC 209/380; 209/391

(57) ABSTRACT

A screened sliding drawer assembly comprises an upper plate comprising a central aperture and at least two side apertures disposed on the sides of the central aperture. The screened sliding drawer assembly further comprises at least two removable lids disposed above the at least two side apertures. The screened sliding drawer assembly further comprises a lower plate comprising a second central aperture. The screened sliding drawer assembly further comprises a glide drawer, disposed between the upper plate and the lower plate, comprising at least one screen. The screened sliding drawer assembly further comprises an output channel disposed below the lower plate.

### CROSS-REFERENCE TO RELATED APPLICATIONS

This application claims priority from U.S. Provisional Patent Application No. 61/762,498, filed on Feb. 8, 2013, which is incorporated by reference herein in its entirety.

### FIELD OF INVENTION

The present disclosure relates to screens used to prevent debris from obstructing the steel-making production process. More particularly, the present disclosure relates to inline carbon screens which include a sliding drawer assembly to allow easy access to the screens for cleaning.

### BACKGROUND

Electric arc furnaces are used in the steel-making process. The steel-making process typically involves passing solid carbon material through a silo and into a dispensing vessel or injector before being passed to a furnace for further processing. When fluctuation in atmospheric temperatures occur, the powered carbon can build up on the side walls of the silo and flake off into the dispensing vessel or injector. In addition, foreign debris in the carbon shipment may also make its way through the silo and into the dispensing vessel or injector, causing further blockage of the carbon to the dispensing vessel or injector and ultimately to the furnace. This can cause downtime and interruptions in production to the detriment of efficiency and cost effectiveness. Therefore, it would be beneficial to have a cost-efficient and timely method of removing the debris that would not require the furnace to be disassembled or powered down for long periods of time.

### SUMMARY

A screened sliding drawer assembly includes an upper plate having a central aperture and at least two side apertures disposed on either side of the central aperture. The assembly also has at least two lids configured to be disposed above the at least two side apertures in the upper plate wherein each of the at least two lids has a handle. A lower plate is disposed below the glide drawer having a second central aperture and a glide drawer disposed between the upper plate and the lower plate. The glide drawer includes a base, a first end wall, a second end wall, a first side wall, a second side wall, and a center dividing wall. The base of the glide drawer has a orifice and second orifice and at least one screen covering the first and second orifices. An output channel is disposed below the lower plate. Additionally, a front plate connects the upper plate and the lower plate and is dimensioned to fit there between. A rear plate connects the upper plate and the lower plate and is dimensioned to fit there between. A first end plate is removeably attached to the upper plate, the lower plate, the front plate, and the rear plate. Additionally, a second end plate is removeably attached to the upper plate, the lower plate, the front plate, and the rear plate.

A method of using the screened sliding drawer assembly to remove debris collected in a carbon injection system comprising the steps of: (a) closing a dispensing valve disposed between the day bin holding tank and the dispensing vessel; (b) opening a pressure valve on the lid of the sliding drawer assembly to insure that the dispensing vessel reaches atmospheric pressure; (c) removing the lid; (d) removing the first end plate and the second plate; (e) moving the glide drawer from a first position to a second position to expose an obstructed portion of the screen to the open lid; (f) cleaning the obstructed portion of the screen through the side aperture in the upper plate; (g) replacing the first and second end plates; (h) reinstalling the lid; (i) opening an injection valve disposed between the dispensing vessel and furnace; and (j) pressurizing the sliding drawer assembly above atmospheric pressure.

A carbon injection system comprising a dispensing vessel, an injection line, and a sliding drawer assembly disposed between the dispensing vessel and the injection line. The sliding drawer comprising an upper plate comprising a central aperture disposed at the outlet of the dispensing vessel and at least two side apertures disposed on the sides of the central aperture. The sliding drawer assembly further comprises at least two removable lids disposed above the at least two side apertures. The sliding drawer assembly further comprises a lower plate comprising a second central aperture. The sliding drawer assembly further comprises a glide drawer, disposed between the upper plate and the lower plate, comprising at least one screen. The sliding drawer assembly further comprises an output channel disposed below the lower plate and coupled to the injection line.

### BRIEF DESCRIPTION OF THE DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale and the proportion of certain elements may be exaggerated for the purpose of illustration.

FIG. 1 is a schematic view of one embodiment of the carbon injection process;

FIG. 2 is a schematic view of one embodiment of a sliding drawer assembly;

FIG. 3 is a partial exploded view of one embodiment of the sliding drawer assembly;

FIG. 4 is a detailed perspective view of one embodiment of a glide drawer used in the sliding drawer assembly;

FIG. 5 is a plan view of one embodiment of a glide drawer used in the sliding drawer assembly;

FIG. 6 is a plan view of one embodiment of a glide drawer used in the sliding drawer assembly;

FIG. 7 is a exploded view of one embodiment of an upper plate used in the sliding drawer assembly; and

FIG. 8 is a exploded view of one embodiment of an lower plate and output channel used in the sliding drawer assembly.

### DETAILED DESCRIPTION

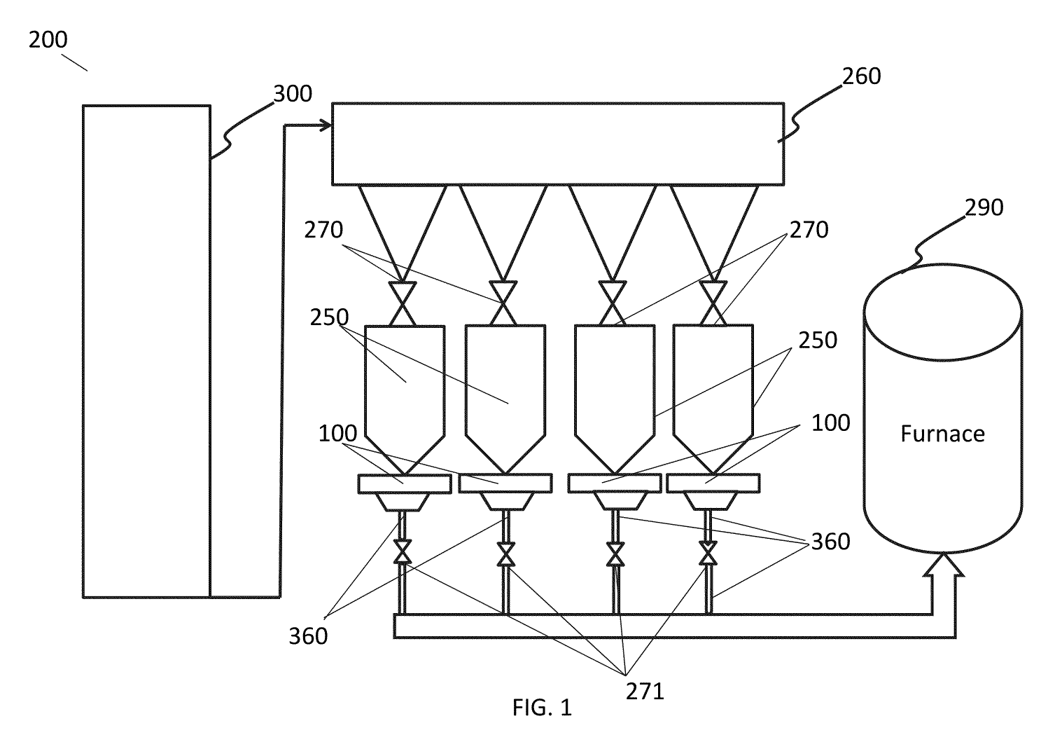

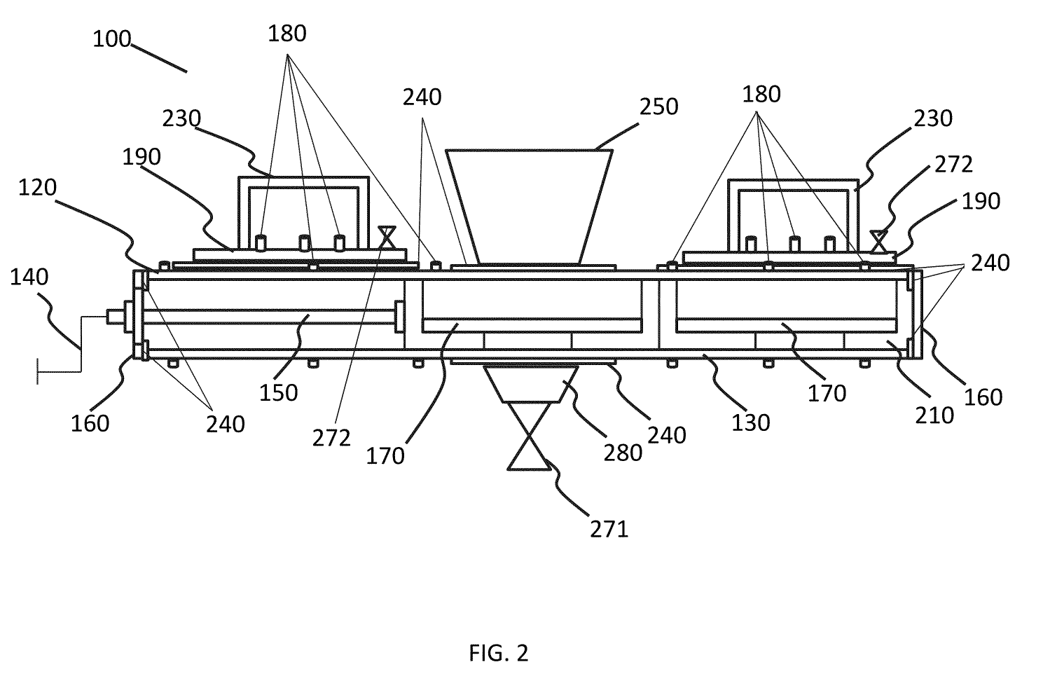

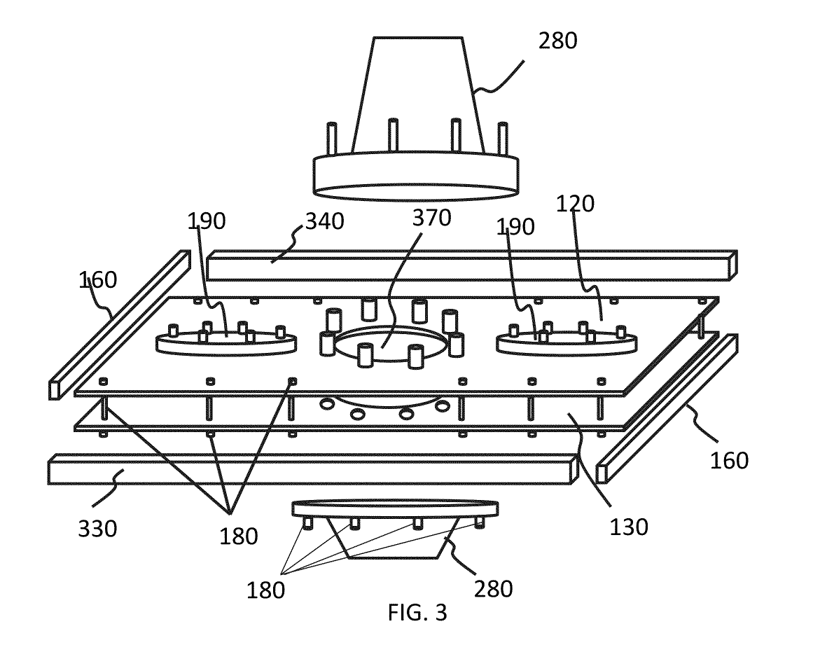

As shown in FIG. 1, screened sliding drawer assemblies 100 are configured to be utilized in line with a carbon injection system 200. The screened sliding drawer assemblies 100 are disposed between the dispensing vessels 250 and the furnace 290. As shown in FIGS. 2 and 3, the screened sliding drawer assembly 100 includes an upper plate 120, a glide drawer 210, screens 170 within the glide drawer 210, a lower plate 130 and an output channel 280. As shown in FIG. 3, the drawer assembly 100 also includes lids 190 configured to cover two side apertures 320 and a central aperture 370 in the upper plate 120. The lids 190 can be removed to expose the screens 170 in the glide drawer 210, allowing efficient access to the screens 170 for removal of debris that may otherwise plug the injections lines 360 (as shown in FIG. 1) leading to the furnace 290, while minimizing the amount of downtime in the coke production process.

As shown in FIG. 1, in the carbon injection system 200 coal stored in a silo 300 is pneumatically conveyed to a day bin holding tank 260. Once the coal is in the day bin holding tank 260 it is divided into four streams and gravity fed into one of four dispensing vessels 250 with the assistance of 25-60 pounds per square inch (psi) of pressure. These dispensing vessels 250 may be MOCA type dispensing vessels 250. Sliding drawer assemblies 100 are disposed between each dispensing vessel 250 and the injection lines 360. The injection lines 360 include and injection valve 271 or load cell which closes and opens in cycles to monitor how much coal is conveyed into the furnace 290. Once the material has passed the sliding drawer assemblies 100, the injection lines 360 merge and the material is injected into the furnace 290. The furnace 290 may be an electric arc furnace. The injection pressure to the furnace 290 is generally about 75 psi.

As shown in FIG. 2, the glide drawer 210 in the sliding drawer assembly 100 is disposed between the upper plate 120 and the lower plate 130. End plates 160 flank each end of the glide drawer 210. The glide drawer 210 includes the arm and handle 150 to assist in pushing and pulling the glide drawer 210 across the upper 120 and lower 130 plates.

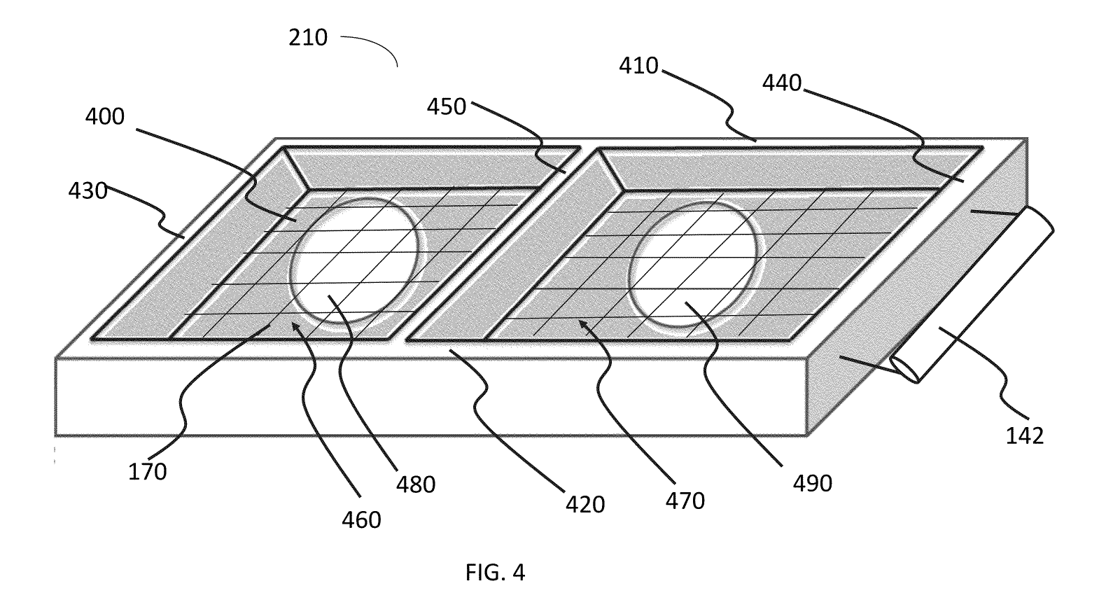

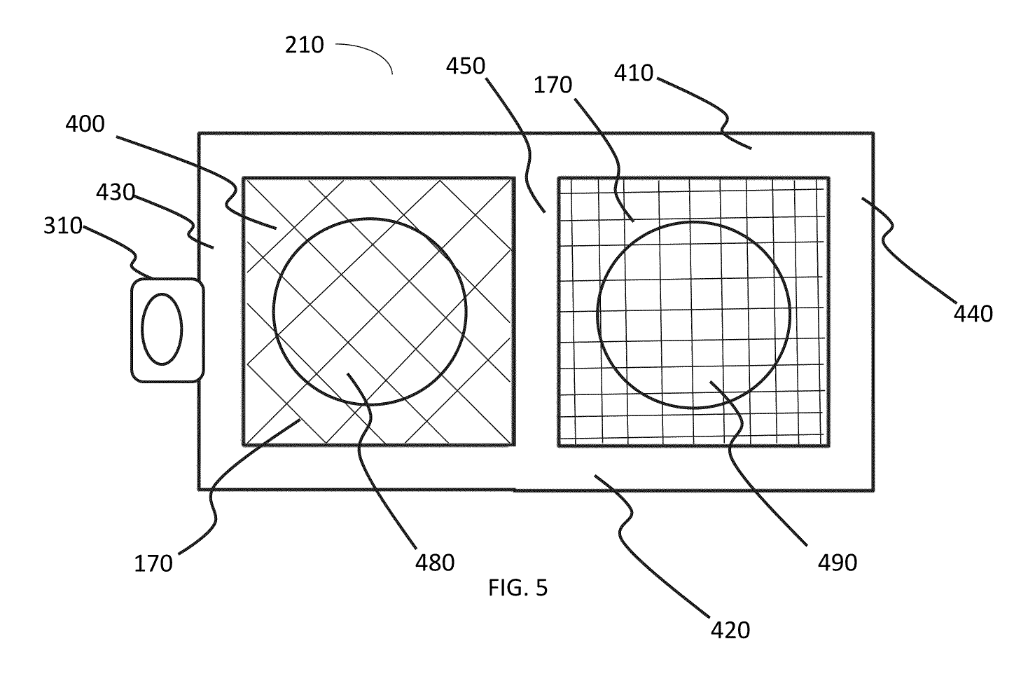

As shown in FIG. 4, the glide drawer 210 includes a base 400, a first end wall 410, a second end wall 420, a first side wall 430, a second side wall 440, and a center dividing wall 450, that defines a first compartment 460, and second compartment 470. The first and second compartments 460 and 470 also include a first orifice 480 and a second orifice 490 disposed in the base 400. In one embodiment, the glide drawer 210 also has an arm and handle 150 disposed on its second side wall 440. Alternatively, as shown in FIG. 5, the glide drawer 210 may have a tab 310 that can receive the handle of a separable arm and handle 150, allowing an operator to push or pull the glide drawer 210 between the upper and lower plates 120, 130.

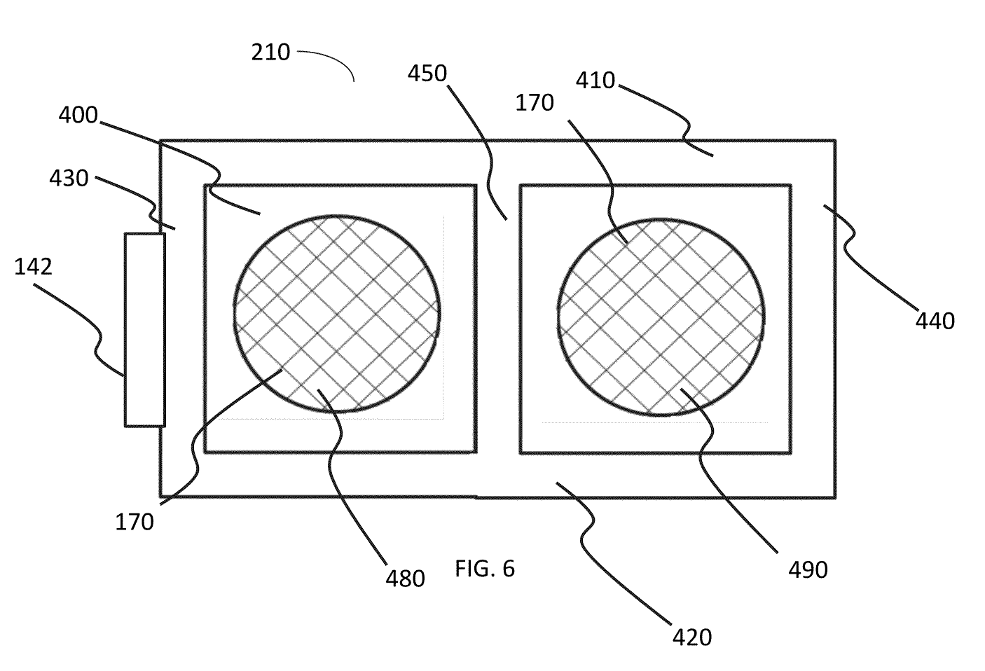

As shown in FIGS. 4 and 5, the glide drawer 210 also includes screens 170 covering the first and second centralized orifices 480 and 490. In this embodiment, the screens 170 may completely cover the base 400 of the glide drawer 210. Alternatively, as shown in FIG. 6, the screens 170 may not cover the entirety of the base 400, but may only cover the first centralized orifice 480 and the second centralized orifice 490. In another embodiment, the screens 170 may cover some other portion of the base 400, so long as the first centralized orifice 480 and the second centralized orifice 490 are covered.

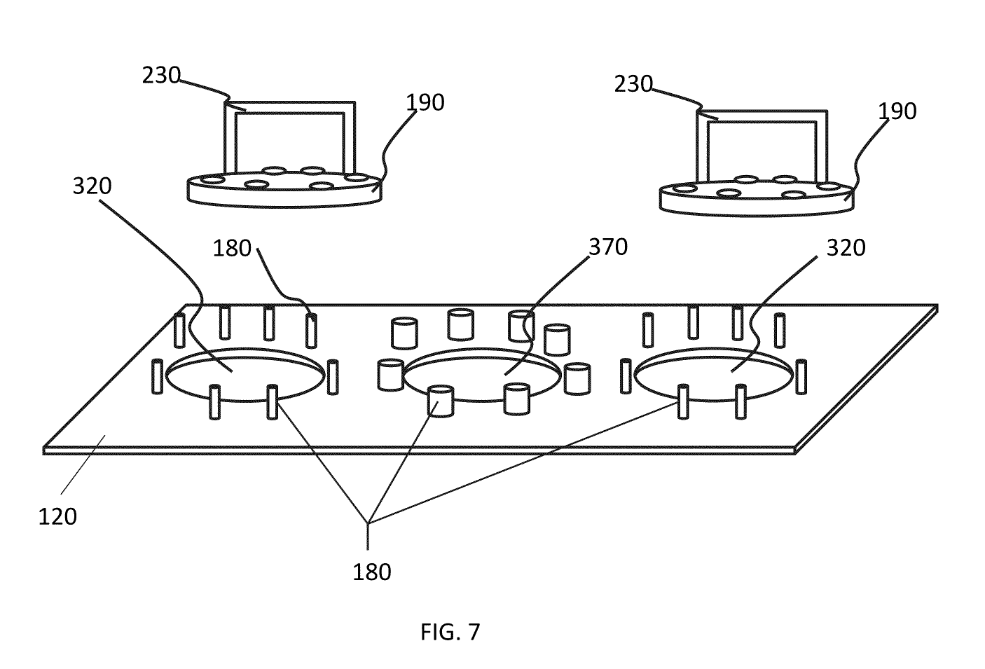

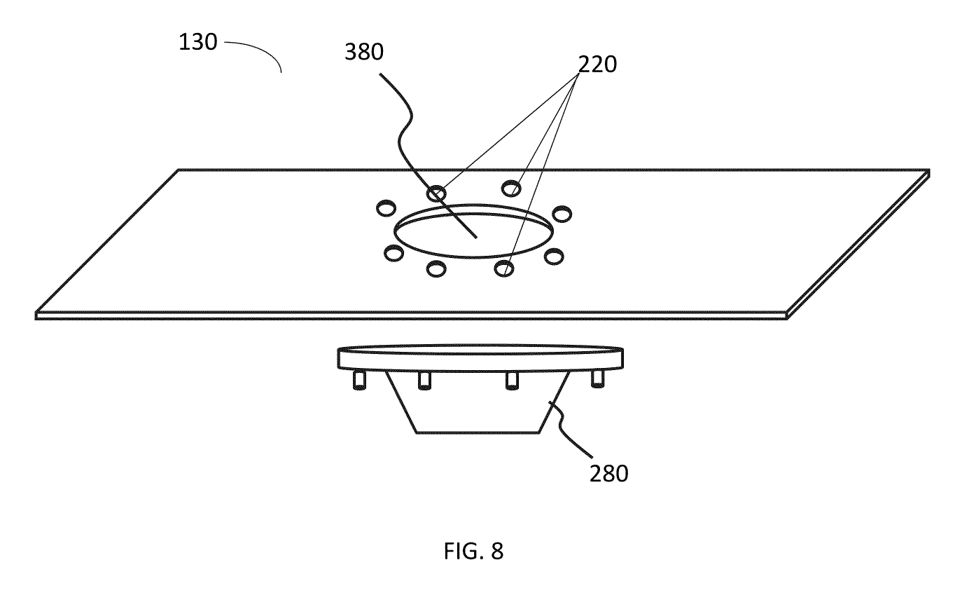

Referring again to FIG. 2, the upper plate 120 is generally disposed at the outlet of the dispensing vessel 250. When in use, gasket 240 may be used to insure an airtight seal between the outlet of the dispensing vessel 250 and the upper plate 120. As shown in FIG. 7, the upper plate 120 further includes a central aperture 370. The central aperture 370 is disposed at the outlet of a dispensing vessel 250 in order to receive material from the dispensing outlet 250. The upper plate 120 also includes at least two side apertures 320 disposed on either side of the central aperture 370. In order to seal the upper plate 120, at the at least two lids 190 are disposed above the two side apertures 320 in the upper plate 120. As shown in FIG. 1, gaskets 240 may be used to insure an airtight seal between the lids 190 and the upper plate 120. Referring again to FIG. 7, each of the lids 190 may also include a lid handle 230. In one embodiment, the upper plate 120 may have a plurality of attachment members 180 for attaching the upper plate 120 to the lower plate 130 (shown in FIG. 8), the lids 190, and the dispensing vessel 250 (as shown in FIG. 3). The attachment members 180 may be placed through holes in the lids 190 and secured with appropriate securing mechanisms. The plurality of attachment members 180 may be ties or fasteners and equivalents thereof.

The lower plate 130 is located below the glide drawer 210. As shown in FIG. 8, the lower plate 130 has a lower central aperture 380. In one embodiment, the lower plate 130 may also have a plurality of openings 220 through which the attachment members 180 may be placed. An output channel 280 may also disposed below the lower central aperture 380 in the lower plate 130.

Referring again to FIG. 3, a front plate 330 and a rear plate 340 that, with the first and second end plates 160 connects the upper plate 120 and the lower plate 130 and are dimensioned to fit there between. Both the first and second end plates 160 may be removed. Gaskets 240 (as shown in FIG. 2) may be used to insure an airtight seal between the end plates 160 and the upper plate 120, the lower plate 130, the front plate 330, and the rear plate 340. In one embodiment, the end plates 160 may be attached using T-bolts to the upper plate 120 and the lower plate 130. The first end plate and the second end plate may also contain slots which are dimensioned so the T-bolts swing into the slots (not shown). The T-bolts can then be tightened over the first and second plates. In this embodiment, either end plate 160 may be removed in order to attach the arm and handle 150 to the sliding drawer and move it between a first position and a second position, to expose an unobstructed centralized opening to the dispensing unit 250.

To remove debris from the glide drawer 210, close the dispensing valve 270 disposed between the day bin holding tank 260 and the dispensing vessel 250 (shown in FIG. 1). The pressure inside sliding drawer assembly 100 may then be relieved by opening a pressure valve 272 which may be located on the lid 190 and removing the lid 190 and the first and second end plates 160. The pressure valve 272 may be a pet cock valve. Using the arm and handle 150, the drawer 210 is either pushed or pulled in order to expose the obstructed screen 170 below the open lid 190, and positioning an unobstructed screen 170 below the dispensing unit 250. The obstructed screen 170 can then be cleaned by hand by reaching through one of the side apertures 320 in the upper plate 120. An air wand can also be used to remove the debris. After cleaning the screen 170, the first and second end plates and the lid 190 are reattached and all nuts are tightened. The pressure valve 272 located on the lid 190 is then closed and the dispensing valve 270 leading to the dispensing vessel 250 is reopened. Pressure is then returned to the dispensing vessel 250. Before restarting the process, the sliding drawer assembly 100 is checked for leaks in order to avoid injury when the process is repressurized.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present disclosure has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the disclosure, in its broader aspects, is not limited to the specific details, the representative apparatus and method, and illustrative examples shown and described. Accordingly, departures may be made from such details without departing from the spirit or scope of the applicant's general inventive concept.

What is claimed is:

1. A screened sliding drawer assembly comprising:
an upper plate comprising a central aperture and at least two side apertures disposed on the sides of the central aperture;
at least two removable lids disposed above the at least two side apertures;
a lower plate comprising a second central aperture;
a glide drawer, disposed between the upper plate and the lower plate, comprising at least one screen; and
an output channel disposed below the lower plate.

2. The screened sliding drawer assembly of claim 1:
wherein the glide drawer comprises a first compartment comprising a first orifice and a second compartment comprising a second orifice; and
wherein the at least one screen covers the first and second orifices.

3. The screened sliding drawer assembly of claim 2, wherein the glide drawer comprises a base, a first end wall, a second end wall, a first side wall, a second side wall, a center dividing wall.

4. The screened sliding drawer assembly of claim 3, wherein the at least one screen covers the base.

5. The screened sliding drawer assembly of claim 2, wherein the glide drawer further comprises an arm and a handle.

6. The screened sliding drawer assembly of claim 2, wherein the glide drawer further comprises a tab configured to receive a handle.

7. The screened sliding drawer assembly of claim 1, further comprising:
a front plate coupled to the upper plate and the lower plate;
a rear plate coupled to the upper plate and the lower plate;
a first end plate removeably coupled to the upper plate, the lower plate, the front plate, and the rear plate; and
a second end plate removeably coupled to the upper plate, the lower plate, the front plate, and the rear plate.

8. The screened sliding drawer assembly of claim 1, wherein the central aperture is disposed at an outlet of a dispensing vessel.

9. The screened sliding drawer assembly of claim 1, further comprising at least two gaskets configured to create an airtight seal between the at least two removable lids and the upper plate.

10. The screened sliding drawer assembly of claim 1, wherein the at least two removable lids comprise a lid handle.

11. The screened sliding drawer assembly of claim 1:
wherein the upper plate further comprises a plurality of attachment members; and
wherein the at least two removable lids comprise a plurality of openings configured to receive the attachment members.

12. A method for filtering debris comprising:
removing a lid of a sliding drawer assembly;
removing a first end plate and a second end plate of a sliding drawer assembly;
moving a glide drawer of the sliding drawer assembly from a first position to a second position;
cleaning the obstructed portion of a screen of the sliding drawer assembly through a side aperture in an upper plate;
replacing the first and second end plates;
closing the lid;

13. The method of claim 12, further comprising the steps of:
closing a dispensing valve disposed between a holding tank and a dispensing vessel;
opening a pressure valve on the lid of the sliding drawer assembly.

14. The method of claim 13, further comprising the steps of:
opening an injection valve disposed between the dispensing vessel and a furnace; and
pressurizing the sliding drawer assembly above atmospheric pressure.

15. A carbon injection system comprising:
a dispensing vessel;
an injection line; and
a sliding drawer assembly disposed between the dispensing vessel and the injection line, the sliding drawer comprising:
an upper plate comprising a central aperture disposed at the outlet of the dispensing vessel and at least two side apertures disposed on the sides of the central aperture;
at least two removable lids disposed above the at least two side apertures;
a lower plate comprising a second central aperture;
a glide drawer, disposed between the upper plate and the lower plate, comprising at least one screen; and
an output channel disposed below the lower plate and coupled to the injection line.

16. The carbon injection system of claim 15:
wherein the glide drawer comprises a base, a first end wall, a second end wall, a first side wall, a second side wall, a center dividing wall, a first orifice disposed between the first side wall and the center dividing wall, and a second orifice disposed between the second side wall and the center dividing wall; and
wherein the at least one screen covers the first and second orifices.

17. The carbon injection system of claim 16, wherein the at least one screen covers at least a portion of the base.

18. The carbon injection system of claim 15, wherein the sliding drawer assembly further comprises:
a front plate coupled to the upper plate and the lower plate;
a rear plate coupled to the upper plate and the lower plate;
a first end plate coupled to the upper plate, the lower plate, the front plate, and the rear plate; and
a second end plate coupled to the upper plate, the lower plate, the front plate, and the rear plate.

19. The carbon injection system of claim 15, wherein the glide drawer further comprises a handle.

20. The carbon injection system of claim 15, further comprising at least two gaskets configured to create an airtight seal between the at least two removable lids and the upper plate.
